(19) United States
(12) Patent Application Publication
(10) Pub. No.: US 2007/0061086 A1
(43) Pub. Date: Mar. 15, 2007

(54) Cardiotoxin molecular toxicology modeling

(76) Inventors: Donna Mendrick, Gaithersburg, MD (US); Mark Porter, Gaithersburg, MD (US); Kory Johnson, Gaithersburg, MD (US); Brandon Higgs, Gaithersburg, MD (US); Arthur Castle, Gaithersburg, MD (US); Michael Elashoff, Gaithersburg, MD (US)

Correspondence Address: COOLEY GODWARD KRONISH LLP;ATTN: Patent Group, Suite 500, 1200 - 19th Street, NW, WASHINGTON, DC, 20036-2402, US

(21) Appl. No.: 11/600,759

(22) Filed: Nov. 17, 2006

Related U.S. Application Data
(63) Continuation of application No. 10/191,803, filed on Jul. 10, 2002, now abandoned.
(60) Provisional application No. 60/303,819, filed on Jul. 10, 2001.
(60) Provisional application No. 60/305,623, filed on Jul. 17, 2001.
(60) Provisional application No. 60/369,351, filed on Apr. 3, 2002.
(60) Provisional application No. 60/377,611, filed on May 6, 2002.

(51) Int. Cl. G06F 19/00

(52) U.S. Cl. 702/20

(57) ABSTRACT

The present invention is based on the elucidation of the global changes in gene expression and the identification of toxicity markers in tissues or cells exposed to a known cardiotoxin. The genes may be used as toxicity markers in drug screening and toxicity assays. The invention includes a database of genes characterized by toxin-induced differential expression that is designed for use with microarrays and other solid-phase probes.

### RELATED APPLICATIONS

This application is a continuation of U.S. application Ser. No. 10/191,803 which claims priority to U.S. Provisional Application 60/303,819; 60/305,623; 60/369,351; and 60/377,611, all of which are herein incorporated by reference in their entirety. This application is also related to U.S. application Ser. Nos. 09/917,800; 10/060,087; and 10/152,319, all of which are also herein incorporated by reference in their entirety.

### SEQUENCE LISTING SUBMISSION ON COMPACT DISC

The Sequence Listing submitted concurrently herewith on compact disc is herein incorporated by reference in its entirety. Three copies of the Sequence Listing, one on each of three compact discs are provided. Copy 1 and Copy 2 are identical. Copies 1 and 2 are also identical to the CRF. Each electronic copy of the Sequence Listing was created on Jun. 19, 2002 with a file size of 1523 KB. The file names are as follows: Copy 1-g15090us.txt; Copy 2—g15090us.txt; and CRF—g15090us.txt.

### BACKGROUND OF THE INVENTION

The need for methods of assessing the toxic impact of a compound, pharmaceutical agent or environmental pollutant on a cell or living organism has led to the development of procedures which utilize living organisms as biological monitors. The simplest and most convenient of these systems utilize unicellular microorganisms such as yeast and bacteria, since they are the most easily maintained and manipulated. In addition, unicellular screening systems often use easily detectable changes in phenotype to monitor the effect of test compounds on the cell. Unicellular organisms, however, are inadequate models for estimating the potential effects of many compounds on complex multicellular animals, as they do not have the ability to carry out biotransformations.

The biotransformation of chemical compounds by multicellular organisms is a significant factor in determining the overall toxicity of agents to which they are exposed. Accordingly, multicellular screening systems may be preferred or required to detect the toxic effects of compounds. The use of multicellular organisms as toxicology screening tools has been significantly hampered, however, by the lack of convenient screening mechanisms or endpoints, such as those available in yeast or bacterial systems.

### SUMMARY OF THE INVENTION

The present invention is based, in part, on the elucidation of the global changes in gene expression in tissues or cells exposed to known toxins, in particular cardiotoxins, as compared to unexposed tissues or cells as well as the identification of individual genes that are differentially expressed upon toxin exposure.

In various aspects, the invention includes methods of predicting at least one toxic effect of a compound, predicting the progression of a toxic effect of a compound, and predicting the cardiotoxicity of a compound. The invention also includes methods of identifying agents that modulate the onset or progression of a toxic response. Also provided are methods of predicting the cellular pathways that a compound modulates in a cell. The invention also includes methods of identifying agents that modulate protein activities.

In a further aspect, the invention includes probes comprising sequences that specifically hybridize to genes in Tables 1-5I. Also included are solid supports comprising at least two of the previously mentioned probes. The invention also includes a computer system that has a database containing information identifying the expression level in a tissue or cell sample exposed to a cardiotoxin of a set of genes in Tables 1-5I.

### DETAILED DESCRIPTION

Many biological functions are accomplished by altering the expression of various genes through transcriptional (e.g. through control of initiation, provision of RNA precursors, RNA processing, etc.) and/or translational control. For example, fundamental biological processes such as cell cycle, cell differentiation and cell death, are often characterized by the variations in the expression levels of groups of genes.

Changes in gene expression are also associated with the effects of various chemicals, drugs, toxins, pharmaceutical agents and pollutants on an organism or cell. Thus, changes in the expression levels of particular genes (e.g. oncogenes or tumor suppressors) may serve as signposts for the presence and progression of toxicity or other cellular responses to exposure to a particular compound.

Monitoring changes in gene expression may also provide certain advantages during drug screening and development. Often drugs are screened for the ability to interact with a major target without regard to other effects the drugs have on cells. These cellular effects may cause toxicity in the whole animal, which prevents the development and clinical use of the potential drug.

The present inventors have examined tissue from animals exposed to known cardiotoxins which induce detrimental heart effects, to identify global changes in gene expression and individual changes in gene expression induced by these compounds. These global changes in gene expression, which can be detected by the production of expression profiles (an expression level of one or more genes), provide useful toxicity markers that can be used to monitor toxicity and/or toxicity progression by a test compound. Some of these markers may also be used to monitor or detect various disease or physiological states, disease progression, drug efficacy and drug metabolism.

Identification of Toxicity Markers

To evaluate and identify gene expression changes that are predictive of toxicity, studies using selected compounds with well characterized toxicity have been conducted by the present inventors to catalogue altered gene expression during exposure in vivo and in vitro. In the present study, cyclophosphamide, ifosfamide, minoxidil, hydralazine, BI-QT, clenbuterol, isoproterenol, norepinephrine, and epinephrine were selected as known cardiotoxins.

Cyclophosphamide, an alkylating agent, is highly toxic to dividing cells and is commonly used in chemotherapy to treat non-Hodgkin's lymphomas, Burkitt's lymphoma and carcinomas of the lung, breast, and ovary (Goodman & Gilman's The Pharmacological Basis of Therapeutics 9^{th} ed., p. 1234, 1237-1239, J. G. Hardman et al., Eds., McGraw Hill, New York, 1996). Additionally, cyclophosphamide is used as an immunosuppressive agent in bone marrow transplantation and following organ transplantation. Though cyclophosphamide is therapeutically useful, it is also associated with cardiotoxicity, nephrotoxicity, and hemorrhagic cystitis. Once in the liver, cyclophosphamide is hydroxylated by the cytochrome P450 mixed function oxidase system. The active metabolites, phosphoramide mustard and acrolein, cross-link DNA and cause growth arrest and cell death. Acrolein has been shown to decrease cellular glutathione levels (Dorr and Lagel (1994), Chem Biol Interact 93: 117-128).

The cardiotoxic effects of cyclophosphamide have been partially elucidated. One study analyzed plasma levels in 19 women with metastatic breast carcinoma who had been treated with cyclophosphamide, thiotepa, and carboplatin (Ayash et al. (1992), J Clin Oncol 10: 995-1000). Of the 19 women in the study, six developed moderate congestive heart failure. In another case study, a 10-year old boy, who had been treated with high-dose cyclophosphamide, developed cardiac arrhythmias and intractable hypotension (Tsai et al. (1990), Am J Pediatr Hematol Oncol 12: 472-476). The boy died 23 days after the transplantation.

Another clinical study examined the relationship between the amount of cyclophosphamide administered and the development of cardiotoxicity (Goldberg et al. (1986), Blood 68: 1114-1118). When the cyclophosphamide dosage was <1.55 g/m²/d, only 1 out of 32 patients had symptoms consistent with cyclophosphamide cardiotoxicity. Yet when the dosage was greater than 1.55 g/m²/d, 13 out of 52 patients were symptomatic. Six of the high-dose patients died of congestive heart failure.

In a related study, Braverman et al. compared the effects of once daily low-dose administration of cyclophosphamide (87+/−11 mg/kg) and twice-daily high-dose treatment (174+/−34 mg/kg) on bone marrow transplantation patients (Braverman et al. (1991), J Clin Oncol 9: 1215-1223). Within a week, the high-dose patients had an increase in left ventricular mass index. Out of five patients who developed clinical cardiotoxicity, four were in the high-dose group.

Ifosfamide, an oxazaphosphorine, is an analog of cyclophosphamide. Whereas cyclophosphamide has two chloroethyl groups on the exocyclic nitrogen, ifosfamide contains one chloroethyl group on the ring nitrogen and the other on the exocyclic nitrogen. Ifosfamide is a nitrogen mustard and alkylating agent, commonly used in chemotherapy to treat testicular, cervical, and lung cancer, as well as sarcomas and lymphomas. Like cyclophosphamide, it is activated in the liver by hydroxylation, but it reacts more slowly and produces more dechlorinated metabolites and chloroacetaldehyde. Comparatively higher doses of ifosfamide are required to match the efficacy of cyclophosphamide.

Alkylating agents can cross-link DNA, resulting in growth arrest and cell death. Despite its therapeutic value, ifosfamide is associated with nephrotoxicity (affecting the proximal and distal renal tubules), urotoxicity, venooclusive disease, myelosuppression, pulmonary fibrosis and central neurotoxicity (Goodman & Gilman's The Pharmacological Basis of Therapeutics 9^{th} ed., p. 1234-1240, J. G. Hardman et al., Eds., McGraw Hill, New York, 1996). Ifosfamide can also cause acute severe heart failure and malignant ventricular arrhythmia, which may be reversible. Death from cardiogenic shock has also been reported (Cecil Textbook of Medicine 20^{th} ed., Bennett et al. eds., p. 331, W.B. Saunders Co., Philadelphia, 1996).

Studies of patients with advanced or resistant lymphomas or carcinomas showed that high-dose ifosfamide treatment produced various symptoms of cardiac disease, including dyspnea, tachycardia, decreased left ventricular contractility and malignant ventricular arrhythmia (Quezado et al. (1993), Ann Intern Med 118: 31-36; Wilson et al. (1992), J Clin Oncol 19: 1712-1722). Other patient studies have noted that ifosfamide-induced cardiac toxicity may be asymptomatic, although it can be detected by electrocardiogram and should be monitored (Pai et al. (2000), Drug Saf 22: 263-302).

Minoxidil is an antihypertensive medicinal agent used in the treatment of high blood pressure. It works by relaxing blood vessels so that blood may pass through them more easily, thereby lowering blood pressure. By applying minoxidil to the scalp, it has recently been shown to be effective at combating hair loss by stimulating hair growth. Once minoxidil is metabolized by hepatic sulfotransferase, it is converted to the active molecule minoxidil N—O sulfate (Goodman & Gilman's The Pharmacological Basis of Therapeutics 9^{th} ed., pp. 796-797, J. G. Hardman et al., Eds., McGraw Hill, New York, 1996). The active minoxidil sulfate stimulates the ATP-modulated potassium channel consequently causing hyperpolarization and relaxation of smooth muscle. Early studies on minoxidil demonstrated that following a single dose of the drug, patients suffering from left ventricular failure exhibited a slightly increased heart rate, a fall in the mean arterial pressure, a fall in the systemic vascular resistance, and a slight increase in cardiac index (Franciosa and Cohn (1981) Circulation 63: 652-657).

Some common side effects associated with minoxidil treatment are an increase in hair growth, weight gain, and a fast or irregular heartbeat. More serious side effects are numbness of the hands, feet, or face, chest pain, shortness of breath, and swelling of the feet or lower legs. Because of the risks of fluid retention and reflex cardiovascular effects, minoxidil is often given concomitantly with a diuretic and a sympatholytic drug.

While minoxidil is effective at lowering blood pressure, it does not lead to a regression of cardiac hypertrophy. To the contrary, minoxidil has been shown to cause cardiac enlargement when administered to normotensive animals (Moravec et al. (1994) J Pharmacol Exp Ther 269: 290-296). Moravec et al. examined normotensive rats that had developed myocardial hypertrophy following treatment with minoxidil. The authors found that minoxidil treatment led to enlargement of the left ventricle, right ventricle, and interventricular septum.

Another rat study investigated the age- and dose-dependency of minoxidil-induced cardiotoxicity (Herman et al. (1996) Toxicology 110: 71-83). Rats ranging in age from 3 months to 2 years were given varying amounts of minoxidil over the period of two days. The investigators observed interstitial hemorrhages at all dose levels, however the hemorrhages were more frequent and severe in the older animals. The 2 year old rats had vascular lesions composed of arteriolar damage and calcification.

Hydralazine, an antihypertensive drug, causes relaxation of arteriolar smooth muscle. Such vasodilation is linked to vigorous stimulation of the sympathetic nervous system, which in turn leads to increased heart rate and contractility, increased plasma renin activity, and fluid retention (Goodman & Gilman's The Pharmacological Basis of Therapeutics 9^{th} ed., p. 794, J. G. Hardman et al., Eds., McGraw Hill, New York, 1996). The increased renin activity leads to an increase in angiotensin II, which in turn causes stimulation of aldosterone and sodium reabsorption.

Hydralazine is used for the treatment of high blood pressure (hypertension) and for the treatment of pregnant women suffering from high blood pressure (pre-eclampsia or eclampsia). Some common side effects associated with hydralazine use are diarrhea, rapid heartbeat, headache, decreased appetite, and nausea. Hydralazine is often used concomitantly with drugs that inhibit sympathetic activity to combat the mild pulmonary hypertension that can be associated with hydralazine usage.

In one hydralazine study, rats were given one of five cardiotoxic compounds (isoproterenol, hydralazine, caffeine, cyclophosphamide, or adriamycin) by intravenous injection (Kemi et al. (1996), J Vet Med Sci 58: 699-702). At one hour and four hours post-dose, early focal myocardial lesions were observed histopathologically. Lesions were observed in the rats treated with hydralazine four hours post-dose. The lesions were found in the inner one third of the left ventricular walls including the papillary muscles.

Another study compared the effects of isoproterenol, hydralazine and minoxidil on young and mature rats (Hanton et al. (1991), Res Commun Chem Pathol Pharmacol 71: 231-234). Myocardial necrosis was observed in both age groups, but it was more severe in the mature rats. Hypotension and reflex tachycardia were also seen in the hydralazine-treated rats. that minoxidil treatment led to enlargement of the left ventricle, right ventricle, and interventricular septum.

Another rat study investigated the age- and dose-dependency of minoxidil-induced cardiotoxicity (Herman et al. (1996) Toxicology 110: 71-83). Rats ranging in age from 3 months to 2 years were given varying amounts of minoxidil over the period of two days. The investigators observed interstitial hemorrhages at all dose levels, however the hemorrhages were more frequent and severe in the older animals. The 2 year old rats had vascular lesions composed of arteriolar damage and calcification.

Hydralazine, an antihypertensive drug, causes relaxation of arteriolar smooth muscle. Such vasodilation is linked to vigorous stimulation of the sympathetic nervous system, which in turn leads to increased heart rate and contractility, increased plasma renin activity, and fluid retention (Goodman & Gilman's The Pharmacological Basis of Therapeutics 9^{th} ed., p. 794, J. G. Hardman et al., Eds., McGraw Hill, New York, 1996). The increased renin activity leads to an increase in angiotensin II, which in turn causes stimulation of aldosterone and sodium reabsorption.

Hydralazine is used for the treatment of high blood pressure (hypertension) and for the treatment of pregnant women suffering from high blood pressure (pre-eclampsia or eclampsia). Some common side effects associated with hydralazine use are diarrhea, rapid heartbeat, headache, decreased appetite, and nausea. Hydralazine is often used concomitantly with drugs that inhibit sympathetic activity to combat the mild pulmonary hypertension that can be associated with hydralazine usage.

In one hydralazine study, rats were given one of five cardiotoxic compounds (isoproterenol, hydralazine, caffeine, cyclophosphamide, or adriamycin) by intravenous injection (Kemi et al. (1996), J Vet Med Sci 58: 699-702). At one hour and four hours post-dose, early focal myocardial lesions were observed histopathologically. Lesions were observed in the rats treated with hydralazine four hours post-dose. The lesions were found in the inner one third of the left ventricular walls including the papillary muscles.

Another study compared the effects of isoproterenol, hydralazine and minoxidil on young and mature rats (Hanton et al. (1991), Res Commun Chem Pathol Pharmacol 71: 231-234). Myocardial necrosis was observed in both age groups, but it was more severe in the mature rats. Hypotension and reflex tachycardia were also seen in the hydralazine-treated rats.

BI-QT, has been shown to induce QC prolongation in dogs and liver alterations in rats. Over a four week period, dogs treated with BI-QT exhibited sedation, decreased body weight, increased liver weight, and slightly increased levels of AST, ALP, and BUN. After three months of treatment, the dogs exhibited signs of cardiovascular effects.

Clenbuterol, a β2 adrenergic agonist, can be used therapeutically as a bronchial dilator for asthmatics. It also has powerful muscle anabolic and lipolytic effects. It has been banned in the United States but continues to be used illegally by athletes to increase muscle growth. In a number of studies, rats treated with clenbuterol developed hypertrophy of the heart and latissimus dorsi muscle (Doheny et al. (1998), Amino Acids 15: 13-25; Murphy et al. (1999), Proc Soc Exp Biol Med 221: 184-187; Petrou et al. (1995), Circulation 92:11483-11489).

In one study, mares treated with therapeutic levels of clenbuterol were compared to mares that were exercised and mares in a control group (Sleeper et al. (2002), Med Sci Sports Exerc 34: 643-650). The clenbuterol-treated mares demonstrated significantly higher left ventricular internal dimension and interventricular septal wall thickness at end diastole. In addition, the clenbuterol-treated mares had significantly increased aortic root dimensions, which could lead to an increased chance of aortic rupture.

In another study, investigators reported a case of acute clenbuterol toxicity in a human (Hoffman et al. (2001), J Toxicol 39: 339-344). A 28-year old woman had ingested a small quantity of clenbuterol, and the patient developed sustained sinus tachycardia, hypokalemia, hypophosphatemia, and hypomagnesemia.

Catecholamines are neurotransmitters that are synthesized in the adrenal medulla and in the sympathetic nervous system. Epinephrine, norepinephrine, and isoproterenol are members of the catecholamine sympathomimetic amine family (Casarett & Doull's Toxicology, The Basic Science of Poisons 6^{th} ed., p. 618-619, C. D. Klaassen, Ed., McGraw Hill, New York, 2001). They are chemically similar by having an aromatic portion (catechol) to which is attached an amine, or nitrogen-containing group.

Isoproterenol, an antiarrhythmic agent, is used therapeutically as a bronchodilator for the treatment of asthma, chronic bronchitis, emphysema, and other lung diseases. Some side effects of usage are myocardial ischemia, arrhythmias, angina, hypertension, and tachycardia. As a β receptor agonist, isoproterenol exerts direct positive inotropic and chronotropic effects. Peripheral vascular resistance is decreased along with the pulse pressure and mean arterial pressure. However, the heart rate increases due to the decrease in the mean arterial pressure.

Norepinephrine, an α and β receptor agonist, is also known as noradrenaline. It is involved in behaviors such as attention and general arousal, stress, and mood states. By acting on β-1 receptors, it causes increased peripheral vascular resistance, pulse pressure and mean arterial pressure. Reflex bradycardia occurs due to the increase in mean arterial pressure. Some contraindications associated with norepinephrine usage are myocardial ischemia, premature ventricular contractions (PVCs), and ventricular tachycardia.

Epinephrine, a potent α and β adrenergic agonist, is used for treating bronchoconstriction and hypotension resulting from anaphylaxis as well as all forms of cardiac arrest. Injection of epinephrine leads to an increase in systolic pressure, ventricular contractility, and heart rate. Some side effects associated with epinephrine usage are cardiac arrhythmias, particularly PVCs, ventricular tachycardia, renal vascular ischemia, increased myocardial oxygen requirements, and hypokalemia.

Toxicity Prediction and Modeling

The genes and gene expression information, gene expression profiles, as well as the portfolios and subsets of the genes provided in Tables 1-5I, may be used to predict at least one toxic effect, including the cardiotoxicity of a test or unknown compound. As used, herein, at least one toxic effect includes, but is not limited to, a detrimental change in the physiological status of a cell or organism. The response may be, but is not required to be, associated with a particular pathology, such as tissue necrosis, myocarditis, arrhythmias, tachycardia, myocardial ischemia, angina, hypertension, hypotension, dyspnea, and cardiogenic shock. Accordingly, the toxic effect includes effects at the molecular and cellular level. Cardiotoxicity is an effect as used herein and includes but is not limited to the pathologies of tissue necrosis, myocarditis, arrhythmias, tachycardia, myocardial ischemia, angina, hypertension, hypotension, dyspnea, and cardiogenic shock. As used herein, a gene expression profile comprises any representation, quantitative or not, of the expression of at least one mRNA species in a cell sample or population and includes profiles made by various methods such as differential display, PCR, hybridization analysis, etc.

In general, assays to predict the toxicity or cardiotoxicity of a test agent (or compound or multi-component composition) comprise the steps of exposing a cell population to the test compound, assaying or measuring the level of relative or absolute gene expression of one or more of the genes in Tables 1-5I and comparing the identified expression level(s) to the expression levels disclosed in the Tables and database(s) disclosed herein. Assays may include the measurement of the expression levels of about 2, 3, 4, 5, 6, 7, 8, 9, 10, 15, 20, 25, 30, 50, 75, 100 or more genes from Tables 1-5I.

In the methods of the invention, the gene expression level for a gene or genes induced by the test agent, compound or compositions may be comparable to the levels found in the Tables or databases disclosed herein if the expression level varies within a factor of about 2, about 1.5 or about 1.0 fold. In some cases, the expression levels are comparable if the agent induces a change in the expression of a gene in the same direction (e.g., up or down) as a reference toxin.

The cell population that is exposed to the test agent, compound or composition may be exposed in vitro or in vivo. For instance, cultured or freshly isolated heart cells, in particular rat heart cells, may be exposed to the agent under standard laboratory and cell culture conditions. In another assay format, in vivo exposure may be accomplished by administration of the agent to a living animal, for instance a laboratory rat.

Procedures for designing and conducting toxicity tests in in vitro and in vivo systems are well known, and are described in many texts on the subject, such as Loomis et al., Loomis's Essentials of Toxicology 4th Ed., Academic Press, New York, 1996; Echobichon, The Basics of Toxicity Testing, CRC Press, Boca Raton, 1992; Frazier, editor, In Vitro Toxicity Testing, Marcel Dekker, New York, 1992; and the like.

In in vitro toxicity testing, two groups of test organisms are usually employed: One group serves as a control and the other group receives the test compound in a single dose (for acute toxicity tests) or a regimen of doses (for prolonged or chronic toxicity tests). Because, in some cases, the extraction of tissue as called for in the methods of the invention requires sacrificing the test animal, both the control group and the group receiving compound must be large enough to permit removal of animals for sampling tissues, if it is desired to observe the dynamics of gene expression through the duration of an experiment.

In setting up a toxicity study, extensive guidance is provided in the literature for selecting the appropriate test organism for the compound being tested, route of administration. dose ranges, and the like. Water or physiological saline (0.9% NaCl in water) is the solute of choice for the test compound since these solvents permit administration by a variety of routes. When this is not possible because of solubility limitations, vegetable oils such as corn oil or organic solvents such as propylene glycol may be used.

Regardless of the route of administration, the volume required to administer a given dose is limited by the size of the animal that is used. It is desirable to keep the volume of each dose uniform within and between groups of animals. When rats or mice are used, the volume administered by the oral route generally should not exceed about 0.005 ml per gram of animal. Even when aqueous or physiological saline solutions are used for parenteral injection the volumes that are tolerated are limited, although such solutions are ordinarily thought of as being innocuous. The intravenous LD₅₀ of distilled water in the mouse is approximately 0.044 ml per gram and that of isotonic saline is 0.068 ml per gram of mouse. In some instances, the route of administration to the test animal should be the same as, or as similar as possible to, the route of administration of the compound to man for therapeutic purposes.

When a compound is to be administered by inhalation, special techniques for generating test atmospheres are necessary. The methods usually involve aerosolization or nebulization of fluids containing the compound. If the agent to be tested is a fluid that has an appreciable vapor pressure, it may be administered by passing air through the solution under controlled temperature conditions. Under these conditions, dose is estimated from the volume of air inhaled per unit time, the temperature of the solution, and the vapor pressure of the agent involved. Gases are metered from reservoirs. When particles of a solution are to be administered, unless the particle size is less than about 2 μm the particles will not reach the terminal alveolar sacs in the lungs. A variety of apparatuses and chambers are available to perform studies for detecting effects of irritant or other toxic endpoints when they are administered by inhalation. The preferred method of administering an agent to animals is via the oral route, either by intubation or by incorporating the agent in the feed.

When the agent is exposed to cells in vitro or in cell culture, the cell population to be exposed to the agent may be divided into two or more subpopulations, for instance, by dividing the population into two or more identical aliquots. In some preferred embodiments of the methods of the invention, the cells to be exposed to the agent are derived from heart tissue. For instance, cultured or freshly isolated rat heart cells may be used.

The methods of the invention may be used generally to predict at least one toxic response, and, as described in the Examples, may be used to predict the likelihood that a compound or test agent will induce various specific heart pathologies, such as tissue necrosis, myocarditis, arrhythmias, tachycardia, myocardial ischemia, angina, hypertension, hypotension, dyspnea, cardiogenic shock, or other pathologies associated with at least one of the toxins herein described. The methods of the invention may also be used to determine the similarity of a toxic response to one or more individual compounds. In addition, the methods of the invention may be used to predict or elucidate the potential cellular pathways influenced, induced or modulated by the compound or test agent due to the similarity of the expression profile compared to the profile induced by a known toxin (see Tables 5-5I).

Diagnostic Uses for the Toxicity Markers

As described above, the genes and gene expression information or portfolios of the genes with their expression information as provided in Tables 1-5I may be used as diagnostic markers for the prediction or identification of the physiological state of a tissue or cell sample that has been exposed to a compound or to identify or predict the toxic effects of a compound or agent. For instance, a tissue sample such as a sample of peripheral blood cells or some other easily obtainable tissue sample may be assayed by any of the methods described above, and the expression levels from a gene or genes from Tables 5-5I may be compared to the expression levels found in tissues or cells exposed to the toxins described herein. These methods may result in the diagnosis of a physiological state in the cell, may be used to diagnose toxin exposure or may be used to identify the potential toxicity of a compound, for instance a new or unknown compound or agent that the subject has been exposed to. The comparison of expression data, as well as available sequence or other information may be done by researcher or diagnostician or may be done with the aid of a computer and databases as described below.

In another format, the levels of a gene(s) of Tables 5-5I, its encoded protein(s), or any metabolite produced by the encoded protein may be monitored or detected in a sample, such as a bodily tissue or fluid sample to identify or diagnose a physiological state of an organism. Such samples may include any tissue or fluid sample, including urine, blood and easily obtainable cells such as peripheral lymphocytes.

Use of the Markers for Monitoring Toxicity Progression

As described above, the genes and gene expression information provided in Tables 5-5I may also be used as markers for the monitoring of toxicity progression, such as that found after initial exposure to a drug, drug candidate, toxin, pollutant, etc. For instance, a tissue or cell sample may be assayed by any of the methods described above, and the expression levels from a gene or genes from Tables 5-5I may be compared to the expression levels found in tissue or cells exposed to the cardiotoxins described herein. The comparison of the expression data, as well as available sequence or other information may be done by a researcher or diagnostician or may be done with the aid of a computer and databases.

Use of the Toxicity Markers for Drug Screening

According to the present invention, the genes identified in Tables 1-5I may be used as markers or drug targets to evaluate the effects of a candidate drug, chemical compound or other agent on a cell or tissue sample. The genes may also be used as drug targets to screen for agents that modulate their expression and/or activity. In various formats, a candidate drug or agent can be screened for the ability to stimulate the transcription or expression of a given marker or markers or to down-regulate or counteract the transcription or expression of a marker or markers. According to the present invention, one can also compare the specificity of a drug's effects by looking at the number of markers which the drug induces and comparing them. More specific drugs will have less transcriptional targets. Similar sets of markers identified for two drugs may indicate a similarity of effects.

Assays to monitor the expression of a marker or markers as defined in Tables 1-51 may utilize any available means of monitoring for changes in the expression level of the nucleic acids of the invention. As used herein, an agent is said to modulate the expression of a nucleic acid of the invention if it is capable of up- or down-regulating expression of the nucleic acid in a cell.

In one assay format, gene chips containing probes to one, two or more genes from Tables 1-5I may be used to directly monitor or detect changes in gene expression in the treated or exposed cell. Cell lines, tissues or other samples are first exposed to a test agent and in some instances, a known toxin, and the detected expression levels of one or more, or preferably 2 or more of the genes of Tables 1-5I are compared to the expression levels of those same genes exposed to a known toxin alone. Compounds that modulate the expression patterns of the known toxin(s) would be expected to modulate potential toxic physiological effects in vivo. The genes in Tables 1-5I are particularly appropriate markers in these assays as they are differentially expressed in cells upon exposure to a known cardiotoxin. Tables 1 and 2 disclose those genes that are differentially expressed upon exposure to the named toxins and their corresponding GenBank Accession numbers. Table 3 discloses the human homologues and the corresponding GenBank Accession numbers of the differentially expressed genes of Tables 1 and 2.

In another format, cell lines that contain reporter gene fusions between the open reading frame and/or the transcriptional regulatory regions of a gene in Tables 1-5I and any assayable fusion partner may be prepared. Numerous assayable fusion partners are known and readily available including the firefly luciferase gene and the gene encoding chloramphenicol acetyltransferase (Alam et al. (1990), Anal Biochem 188: 245-254). Cell lines containing the reporter gene fusions are then exposed to the agent to be tested under appropriate conditions and time. Differential expression of the reporter gene between samples exposed to the agent and control samples identifies agents which modulate the expression of the nucleic acid.

Additional assay formats may be used to monitor the ability of the agent to modulate the expression of a gene identified in Tables 5-5I. For instance, as described above, mRNA expression may be monitored directly by hybridization of probes to the nucleic acids of the invention. Cell lines are exposed to the agent to be tested under appropriate conditions and time, and total RNA or mRNA is isolated by standard procedures such those disclosed in Sambrook et al. (Molecular Cloning: A Laboratory Manual 2nd Ed., Cold Spring Harbor Laboratory Press, Cold Spring Harbor, N.Y., 1989).

In another assay format, cells or cell lines are first identified which express the gene products of the invention physiologically. Cells and/or cell lines so identified would be expected to comprise the necessary cellular machinery such that the fidelity of modulation of the transcriptional apparatus is maintained with regard to exogenous contact of agent with appropriate surface transduction mechanisms and/or the cytosolic cascades. Further, such cells or cell lines may be transduced or transfected with an expression vehicle (e.g., a plasmid or viral vector) construct comprising an operable non-translated 5′-promoter containing end of the structural gene encoding the gene products of Tables 1-5I fused to one or more antigenic fragments or other detectable markers, which are peculiar to the instant gene products, wherein said fragments are under the transcriptional control of said promoter and are expressed as polypeptides whose molecular weight can be distinguished from the naturally occurring polypeptides or may further comprise an immunologically distinct or other detectable tag. Such a process is well known in the art (see Sambrook et al., supra).

Cells or cell lines transduced or transfected as outlined above are then contacted with agents under appropriate conditions; for example, the agent comprises a pharmaceutically acceptable excipient and is contacted with cells comprised in an aqueous physiological buffer such as phosphate buffered saline (PBS) at physiological pH, Eagles balanced salt solution (BSS) at physiological pH, PBS or BSS comprising serum or conditioned media comprising PBS or BSS and/or serum incubated at 37° C. Said conditions may be modulated as deemed necessary by one of skill in the art. Subsequent to contacting the cells with the agent, said cells are disrupted and the polypeptides of the lysate are fractionated such that a polypeptide fraction is pooled and contacted with an antibody to be further processed by immunological assay (e.g., ELISA, immunoprecipitation or Western blot). The pool of proteins isolated from the agent-contacted sample is then compared with the control samples (no exposure and exposure to a known toxin) where only the excipient is contacted with the cells and an increase or decrease in the immunologically generated signal from the agent-contacted sample compared to the control is used to distinguish the effectiveness and/or toxic effects of the agent.

Use of Toxicity Markers to Identify Agents that Modulate Protein Activity or Levels

Another embodiment of the present invention provides methods for identifying agents that modulate at least one activity of a protein(s) encoded by the genes in Tables 1-5I. Such methods or assays may utilize any means of monitoring or detecting the desired activity.

In one format, the relative amounts of a protein (Tables 1-5I) between a cell population that has been exposed to the agent to be tested compared to an unexposed control cell population and a cell population exposed to a known toxin may be assayed. In this format, probes such as specific antibodies are used to monitor the differential expression of the protein in the different cell populations. Cell lines or populations are exposed to the agent to be tested under appropriate conditions and time. Cellular lysates may be prepared from the exposed cell line or population and a control, unexposed cell line or population. The cellular lysates are then analyzed with the probe, such as a specific antibody.

Agents that are assayed in the above methods can be randomly selected or rationally selected or designed. As used herein, an agent is said to be randomly selected when the agent is chosen randomly without considering the specific sequences involved in the association of a protein of the invention alone or with its associated substrates, binding partners, etc. An example of randomly selected agents is the use a chemical library or a peptide combinatorial library, or a growth broth of an organism.

As used herein, an agent is said to be rationally selected or designed when the agent is chosen on a nonrandom basis which takes into account the sequence of the target site and/or its conformation in connection with the agent's action. Agents can be rationally selected or rationally designed by utilizing the peptide sequences that make up these sites. For example, a rationally selected peptide agent can be a peptide whose amino acid sequence is identical to or a derivative of any functional consensus site.

The agents of the present invention can be, as examples, peptides, small molecules, vitamin derivatives, as well as carbohydrates. Dominant negative proteins, DNAs encoding these proteins, antibodies to these proteins, peptide fragments of these proteins or mimics of these proteins may be introduced into cells to affect function. “Mimic” used herein refers to the modification of a region or several regions of a peptide molecule to provide a structure chemically different from the parent peptide but topographically and functionally similar to the parent peptide (see G. A. Grant in: Molecular Biology and Biotechnology, Meyers, ed., pp. 659-664, VCH Publishers, New York, 1995). A skilled artisan can readily recognize that there is no limit as to the structural nature of the agents of the present invention.

Nucleic Acid Assay Formats

As previously discussed, the genes identified as being differentially expressed upon exposure to a known cardiotoxin (Tables 1-5I) may be used in a variety of nucleic acid detection assays to detect or quantify the expression level of a gene or multiple genes in a given sample. The genes described in Tables 1-5I may also be used in combination with one or more additional genes whose differential expression is associate with toxicity in a cell or tissue. In preferred embodiments, the genes in Tables 5-5I may be combined with one or more of the genes described in prior and related application 60/303,819; 60/305,623; 60/369,351; 60/377,611; Ser. Nos. 09/917,800; 10/060,087; and 10/152,319, all of which are incorporated by reference on page 1 of this application.

Any assay format to detect gene expression may be used. For example, traditional Northern blotting, dot or slot blot, nuclease protection, primer directed amplification, RT-PCR, semi- or quantitative PCR, branched-chain DNA and differential display methods may be used for detecting gene expression levels. Those methods are useful for some embodiments of the invention. In cases where smaller numbers of genes are detected, amplification based assays may be most efficient. Methods and assays of the invention, however, may be most efficiently designed with hybridization-based methods for detecting the expression of a large number of genes.

Any hybridization assay format may be used, including solution-based and solid support-based assay formats. Solid supports containing oligonucleotide probes for differentially expressed genes of the invention can be filters, polyvinyl chloride dishes, particles, beads, microparticles or silicon or glass based chips, etc. Such chips, wafers and hybridization methods are widely available, for example, those disclosed by Beattie (WO 95/11755).

Any solid surface to which oligonucleotides can be bound, either directly or indirectly, either covalently or non-covalently, can be used. A preferred solid support is a high density array or DNA chip. These contain a particular oligonucleotide probe in a predetermined location on the array. Each predetermined location may contain more than one molecule of the probe, but each molecule within the predetermined location has an identical sequence. Such predetermined locations are termed features. There may be, for example, from 2, 10, 100, 1000 to 10,000, 100,000, 400,000 or 1,000,000 or more of such features on a single solid support. The solid support, or the area within which the probes are attached may be on the order of about a square centimeter. Probes corresponding to the genes of Tables 5-5I or from the related applications described above may be attached to single or multiple solid support structures, e.g., the probes may be attached to a single chip or to multiple chips to comprise a chip set.

Oligonucleotide probe arrays for expression monitoring can be made and used according to any techniques known in the art (see for example, Lockhart et al. (1996), Nat Biotechnol 14: 1675-1680; McGall et al. (1996), Proc Nat Acad Sci USA 93: 13555-13460). Such probe arrays may contain at least two or more oligonucleotides that are complementary to or hybridize to two or more of the genes described in Tables 5-5I. For instance, such arrays may contain oligonucleotides that are complementary to or hybridize to at least 2, 3, 4, 5, 6, 7, 8, 9, 10, 20, 30, 50, 70, 100 or more of the genes described herein. Preferred arrays contain all or nearly all of the genes listed in Tables 1-5I, or individually, the gene sets of Tables 5-5I. In a preferred embodiment, arrays are constructed that contain oligonucleotides to detect all or nearly all of the genes in any one of or all of Tables 1-5I on a single solid support substrate, such as a chip.

The sequences of the expression marker genes of Tables 1-5I are in the public databases. Table 1 provides the GenBank Accession Number or NCBI RefSeq ID for each of the sequences (see www.ncbi.nlm.nih.gov/) as well as a corresponding SEQ ID NO. in the sequence listing filed with this application. Table 3 provides the LocusLink and Unigene names and descriptions for the human homologues of the genes described in Tables 1 and 2. The sequences of the genes in GenBank and/or RefSeq are expressly herein incorporated by reference in their entirety as of the filing date of this application, as are related sequences, for instance, sequences from the same gene of different lengths, variant sequences, polymorphic sequences, genomic sequences of the genes and related sequences from different species, including the human counterparts, where appropriate. These sequences may be used in the methods of the invention or may be used to produce the probes and arrays of the invention. In some embodiments, the genes in Tables 1-5I that correspond to the genes or fragments previously associated with a toxic response may be excluded from the Tables.

As described above, in addition to the sequences of the GenBank Accession Numbers or NCBI RefSeq ID's disclosed in the Tables 1-5I, sequences such as naturally occurring variants or polymorphic sequences may be used in the methods and compositions of the invention. For instance, expression levels of various allelic or homologous forms of a gene disclosed in Tables 1-5I may be assayed. Any and all nucleotide variations that do not significantly alter the functional activity of a gene listed in the Tables 1-5I, including all naturally occurring allelic variants of the genes herein disclosed, may be used in the methods and to make the compositions (e.g., arrays) of the invention.

Probes based on the sequences of the genes described above may be prepared by any commonly available method. Oligonucleotide probes for screening or assaying a tissue or cell sample are preferably of sufficient length to specifically hybridize only to appropriate, complementary genes or transcripts. Typically the oligonucleotide probes will be at least about 10, 12, 14, 16, 18, 20 or 25 nucleotides in length. In some cases, longer probes of at least 30, 40, or 50 nucleotides will be desirable.

As used herein, oligonucleotide sequences that are complementary to one or more of the genes described in Tables 1-5I refer to oligonucleotides that are capable of hybridizing under stringent conditions to at least part of the nucleotide sequences of said genes, their encoded RNA or mRNA, or amplified versions of the RNA such as cRNA. Such hybridizable oligonucleotides will typically exhibit at least about 75% sequence identity at the nucleotide level to said genes, preferably about 80% or 85% sequence identity or more preferably about 90% or 95% or more sequence identity to said genes.

“Bind(s) substantially” refers to complementary hybridization between a probe nucleic acid and a target nucleic acid and embraces minor mismatches that can be accommodated by reducing the stringency of the hybridization media to achieve the desired detection of the target polynucleotide sequence.

The terms “background” or “background signal intensity” refer to hybridization signals resulting from non-specific binding, or other interactions, between the labeled target nucleic acids and components of the oligonucleotide array (e.g., the oligonucleotide probes, control probes, the array substrate, etc.). Background signals may also be produced by intrinsic fluorescence of the array components themselves. A single background signal can be calculated for the entire array, or a different background signal may be calculated for each target nucleic acid. In a preferred embodiment, background is calculated as the average hybridization signal intensity for the lowest 5% to 10% of the probes in the array, or, where a different background signal is calculated for each target gene, for the lowest 5% to 10% of the probes for each gene. Of course, one of skill in the art will appreciate that where the probes to a particular gene hybridize well and thus appear to be specifically binding to a target sequence, they should not be used in a background signal calculation. Alternatively, background may be calculated as the average hybridization signal intensity produced by hybridization to probes that are not complementary to any sequence found in the sample (e.g. probes directed to nucleic acids of the opposite sense or to genes not found in the sample such as bacterial genes where the sample is mammalian nucleic acids). Background can also be calculated as the average signal intensity produced by regions of the array that lack any probes at all.

The phrase “hybridizing specifically to” or “specifically hybridizes” refers to the binding, duplexing, or hybridizing of a molecule substantially to or only to a particular

We claim:

1. A method of predicting for the cardiotoxicity of a test compound, comprising:
(a) preparing a gene expression profile of at least ten genes from a heart tissue or heart cell sample exposed to the test compound; and
(b) comparing the expression levels of said genes from the gene expression profile to a database comprising the gene expression levels of said genes derived from heart tissue or heart cell samples that have been exposed to at least one known cardiotoxin, wherein said at least ten genes are selected from the genes in any one of Tables 5-5I, thereby predicting for the cardiotoxicity of the test compound.

2. A method of claim 1, wherein the gene expression profile prepared from the heart tissue or heart cell sample comprises the level of expression for at least 100 genes.

3. A method of claim 2, wherein the level of expression is compared to a Toxic Mean and/or NonToxic Mean value in a database comprising any one of Tables 5-5I.

4. A method of claim 3, wherein the level of expression is normalized prior to comparison.

5. A method of claim 1, wherein the database comprises substantially all of the data or information in any one of Tables 5-5I.

6. A method of predicting the cardiotoxicity of a test compound, comprising:
(a) detecting the level of expression in a heart tissue or heart cell sample exposed to the compound of ten or more genes from Tables 5-5I; wherein differential expression of the genes in Tables 5-5I is indicative of cardiotoxicity.

7. The method of claim 1, wherein the expression levels of at least 15 genes are detected.

8. The method of claim 1, wherein the expression levels of at least 20 genes are detected.

9. The method of claim 1, wherein the expression levels of at least 25 genes are detected.

10. The method of claim 1, wherein the expression levels of at least 30 genes are detected.

11. The method of claim 1, wherein the expression levels of at least 50 genes are detected.

12. The method of claim 1, wherein the expression levels of at least 75 genes are detected.

13. The method of claim 1, wherein the expression levels of at least 100 genes are detected.

14. A method of claim 8, wherein the cardiotoxicity is associated with at least one heart disease pathology selected from the group consisting of myocarditis, arrhythmias, tachycardia, myocardial ischemia, angina, hypertension, hypotension, dyspnea, and cardiogenic shock.

15. A method of claim 6, wherein nearly all of the genes in Tables 5-5I are detected.

16. A method of claim 15, wherein all of the genes in at least one of Tables 5-5I are detected.

17. A method of claim 1, wherein the compound exposure is in vivo or in vitro.

18. A method claim 1, wherein the level of expression is detected by an amplification or hybridization assay.

19. A method of claim 18, wherein the amplification assay is quantitative or semi-quantitative PCR.

20. A method of claim 18, wherein the hybridization assay is selected from the group consisting of Northern blot, dot or slot blot, nuclease protection and microarray assays.

21. The method of claim 1, wherein the heart cell or heart tissue sample is exposed to the test compound in vivo and the heart cell or heart tissue samples from which database information is derived are exposed to the at least one known cardiotoxin in vivo.

22. A method of claim 21, wherein the cardiotoxicity is associated with at least one heart disease pathology selected from the group consisting of myocarditis, arrhythmias, tachycardia, myocardial ischemia, angina, hypertension, hypotension, dyspnea, and cardiogenic shock.

23. A method of claim 21, wherein the cardiotoxin is selected from the group consisting of cyclophosphamide, ifosfamide, minoxidil, hydralazine, BI (Boeringer Ingelheim)-QT, clenbuterol, isoproterenol, norepinephrine, and epinephrine.

24. A method of claim 1, wherein the gene expression profile is produced by hybridization of nucleic acids to a microarray.

25. A method of claim 1, wherein the heart cell or heart tissue sample is a rat heart cell or rat heart tissue sample.

26. A method of claim 1, wherein the genes in Tables 5-5I are rat genes.
